(19) United States
(12) Patent Application Publication
(10) Pub. No.: US 2001/0017755 A1
(43) Pub. Date: Aug. 30, 2001

(54) Semiconductor integrated circuit provided with input protection device, assembly circuit board of the semiconductor integrated circuit, and method of removing the input protection function

(76) Inventor: Yoshiaki Toyoshima, Kashiwa-shi (JP)

Correspondence Address: Pillsbury Madison & Sutro, LLP, East Tower, Ninth Floor, 1100 New York Avenue, N.W., Washington, DC, 20005-3918, US

(21) Appl. No.: 09/790,646

(22) Filed: Feb. 23, 2001

(30) Foreign Application Priority Data
Feb. 25, 2000 (JP) 2000-049590

(51) Int. Cl. H02H 9/00

(52) U.S. Cl. 361/56; 361/91.5

(57) ABSTRACT

The present invention is intended to prevent an element breakdown derived from an electrostatic discharge (ESD) during the handling such as packaging of an LSI chip, packing and transportation, and to divide the input protection diodes from the signal input terminal during the ordinary use of the LSI so as to prevent the inhibition of a high speed operation and a latch-up phenomenon. The first and second diodes, each connected in reverse polarity between the signal input terminal and any of a voltage supply node and a ground node inside the LSI, are divided from the signal input terminal of the LSI by controlling the first and second fuse elements, each connected between the signal input terminal and any of the first and second diodes, from the outside after the LSI is mounted to the assembly circuit board.

### CROSS-REFERENCE TO RELATED APPLICATIONS

This application is based upon and claims the benefit of priority from the prior Japanese Patent Application No. 2000-049590, filed Feb. 25, 2000, the entire contents of which are incorporated herein by reference.

### BACKGROUND OF THE INVENTION

The present invention relates to a semiconductor integrated circuit having an input protection device, an assembly circuit board of the semiconductor integrated circuit for mounting the semiconductor integrated circuit thereon, and a method of removing the input protection function, particularly, to an input protection device of an LSI having an input circuit of MOS gate and used in an integrated circuit operated under high frequencies of, for example, GHz range.

Included in an LSI having a MOS gate input circuit, e.g., MOS LSI, is a protection device (input protection diode) for performing discharge so as to prevent the electrostatic charge from reaching a MOS gate of a signal input circuit within an integrated circuit when an electrostatic discharge (ESD) is performed from a human body or various machines to a signal input terminal in handling the LSI before the LSI is mounted to an assembly circuit board.

FIG. 1 exemplifies a typical input protection device formed in a MOS integrated circuit. As shown in FIG. 1, a signal input terminal 10 is connected to an internal element of an integrated circuit (MOS gate in an input circuit 11). A diode D₁ is connected in reverse polarity between a voltage supply node (V_{cc} voltage supply line) within the integrated circuit and the signal input terminal 10. Also, a diode D₂ is connected in reverse polarity between the signal input terminal 10 and a ground node (ground line) within the integrated circuit.

The diodes D₁, D₂ are biased in reverse polarity during the normal operation of the integrated circuit described above and do not affect the circuit operation.

On the other hand, when a positive ESD is applied to the signal input terminal 10, the positive ESD is discharged to the V_{cc} voltage supply line as a forward current of the diode D₁ and is discharged to the ground line as a reverse current exceeding the breakdown voltage of the diode D₂, with the result that the positive ESD is prevented from reaching the internal element of the integrated circuit. Also, when a negative ESD is applied to the signal input terminal, the negative ESD is discharged to the ground line as a forward current of the diode D₂ and is discharged to the V_{cc} voltage supply line as a reverse current exceeding the breakdown voltage of the diode D₁, with the result that the ESD is prevented from reaching the internal element of the integrated circuit.

However, when it comes to an LSI operated in high frequencies of GHz range, e.g., an LSI for a mobile telephone, the parasitic capacitance generated by the PN junction of each of the input protection diodes D₁ and D₂ inhibits the transmission of high frequency signals so as to provide a cause of inhibiting the high speed operation, with the result that a problem is posed by the connection of the input protection diodes D₁ and D₂ to the signal input terminal 10.

Also, in general, the input protection diodes D₁ and D₂ connected to the signal input terminal 10 of the integrated circuit cause latch-up in some cases, which is a problem that must be solved.

As described above, the input protection diode of the conventional LSI brings about the problem that the parasitic capacitance of the diode inhibits transmission of high frequency signals so as to provide a cause of inhibiting a high speed operation and the problem that the diode brings about latch-up.

It should be noted that the input protection of an integrated circuit is highly required in the handling steps such as the sealing of a silicon chip in a package, the packing and the transportation of the packaged integrated circuit and in the step of mounting the integrated circuit to an assembly circuit board. After the LSI is mounted to the assembly circuit board and connected to a wiring, the electrostatic capacitance of the entire circuit board is increased and the signal input terminal of the LSI itself is less likely to be exposed to the outside. Under the circumstances, the necessity of the input protection is lowered. As a matter of fact, the semiconductor device is substantially free from any inconvenience even if the input protection device is omitted.

### BRIEF SUMMARY OF THE INVENTION

A first object of the present invention, which has been achieved in view of the situation described above, is to provide a semiconductor integrated circuit provided with an input protection device capable of preventing the element breakdown derived from ESD in the handling such as the packaging of an integrated circuit chip, the packing, and the transportation, and also capable of dividing the input protection diode from the signal input terminal during the ordinary use so as to prevent the high speed operation from being inhibited by the input protection diode and to prevent latch-up, and to provide an assembly circuit board for mounting the semiconductor integrated circuit thereon.

A second object of the present invention is to provide a method of removing the input protection function of a semiconductor integrated circuit, in which an input protection diode is made dividable from the signal input terminal prior to the ordinary use of the semiconductor integrated circuit so as to prevent a high speed operation from being inhibited by the input protection diode and to prevent latch-up.

According to a first aspect of the present invention, there is provided a semiconductor integrated circuit having a gate input circuit and a protection device of the gate input circuit connected to a signal input terminal, wherein the protection device comprises at least one protection diode, a first terminal of the protection diode being connected to any of first and second voltage supply lines of the semiconductor integrated circuit, and a second terminal of the protection diode being connected to a node in an input signal path formed between the signal input terminal and the gate input circuit, and the node and the second terminal of the protection diode are formed dividable by the control from the outside.

According to a second aspect of the present invention, there is provided an assembly circuit board mounting a semiconductor integrated circuit on a circuit board, the semiconductor integrated circuit having a gate input circuit and a protection device of the gate input circuit connected to a signal input terminal, the protection device comprising at least one protection diode, a first terminal of the protection diode being connected to any one of first and second voltage supply lines of the semiconductor integrated circuit, a second terminal of the protection diode being connected to a node in the input signal path formed between the signal input terminal and the gate input circuit, wherein the protection device comprises a fuse element formed between the node and the second terminal of the protection diode, and the circuit board comprises a signal input wiring pattern connected to the signal input terminal and a voltage supply wiring pattern connected to any one of the first and second voltage supply lines.

According to a third aspect of the present invention, there is provided a method of removing the input protection function from a semiconductor integrated circuit having a gate input circuit and a protection device of the gate input circuit connected to a signal input terminal, the protection device comprising at least one protection diode, the first terminal of the protection diode being connected to any one of first and second voltage supply lines of the semiconductor integrated circuit; the second terminal of the protection diode being connected to a node in an input signal path formed between the signal input terminal and the gate input circuit, a fuse element being formed between the node and the second terminal of the protection diode, wherein the method comprises the step of cutting away the fuse element by applying a forward current flowing from the anode to the cathode of the protection diode from the signal input terminal after manufacture of the semiconductor integrated circuit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a circuit diagram exemplifying a typical protection device formed in a conventional MOS type integrated circuit;

FIG. 2 is a circuit diagram showing an input protection device formed inside an LSI according to a first embodiment of the present invention;

FIG. 3 is an equivalent circuit diagram showing as a model an ESD applying operation to the input protection device shown in FIG. 2;

FIG. 4A exemplifies a planar pattern of each fuse element shown in FIG. 2;

FIG. 4B is a cross sectional view exemplifying the construction of each fuse element shown in FIG. 2;

FIG. 5 is a graph showing experimental data in respect of the time required for melting down an aluminum wire insulated with a silicon dioxide film;

FIG. 6 is a plan view schematically exemplifying an LSI assembly circuit board according to a second embodiment of the present invention;

FIG. 7A exemplifies a method of removing the input protecting function on the V_{cc} side of an LSI assembly circuit board according to a third embodiment of the present invention;

FIG. 7B exemplifies a method of removing the input protecting function on the GND side of an LSI assembly circuit board according to the third embodiment of the present invention;

FIG. 8A is a plan view showing a fuse element connected to a protection diode included in an LSI input protection device according to a fourth embodiment of the present invention;

FIG. 8B is a cross sectional view showing a fuse element connected to a protection diode included in an LSI input protection device according to the fourth embodiment of the present invention; and

FIG. 9 is a graph showing the relationship between the melt-down time of the fuse element shown in FIG. 8, which is formed of a polycrystalline silicon (polysilicon) film, and the applied DC current.

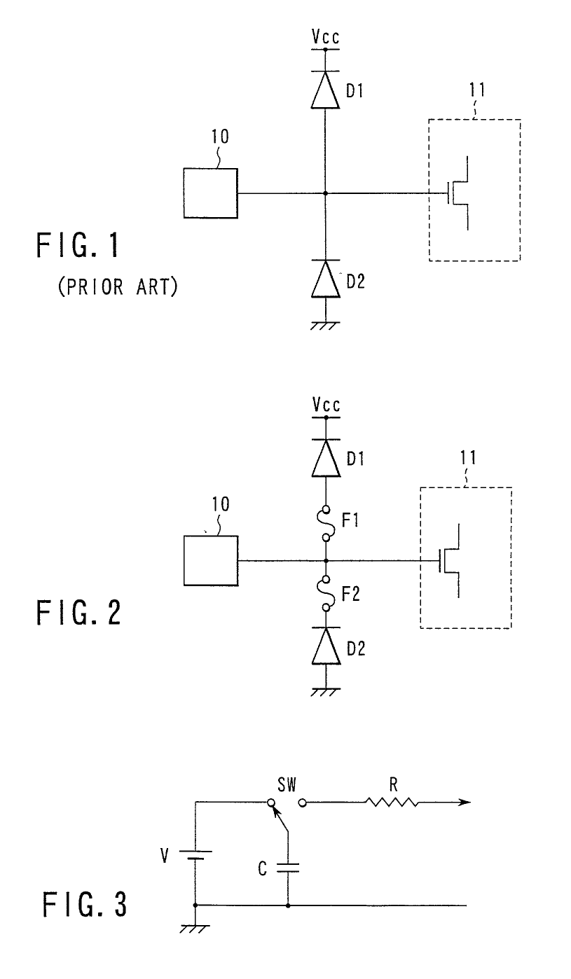

### DETAILED DESCRIPTION OF THE INVENTION

Some embodiments of the present invention will now be described with reference to the accompanying drawings.

FIG. 2 is directed to a semiconductor integrated circuit according to a first embodiment of the present invention. The semiconductor integrated circuit according to the first embodiment is featured in that the input protection device inside the LSI can be isolated from the signal input terminal by an external control after manufacture of the LSI.

Specifically, FIG. 2 shows the construction of the input protection device formed inside the LSI according to the first embodiment of the present invention. As shown in FIG. 2, an internal element of the integrated circuit, i.e., a MOS gate included in a MOS gate input circuit 11, is connected to a signal input terminal 10. A series circuit consisting of a first diode D₁ for the input protection and a first fuse element F₁ is connected to a node in an input signal path formed between the signal input terminal 10 and the MOS gate such that one terminal of the first fuse element F₁ is connected to the node, the other terminal of the first fuse element F₁ is connected to the anode of the first diode D₁ and the cathode of the first diode D₁ is connected to a first voltage supply node (Vcc voltage supply line). The first diode D₁ is, therefore, connected in reverse polarity between the Vcc voltage supply line and the signal input terminal 10 via the first fuse element F₁.

Likewise, a series circuit consisting of a second diode D₂ for the input protection and a second fuse element F₂ is connected to the node in the input signal path formed between the signal input terminal 10 and the MOS gate such that one terminal of the second fuse element F₂ is connected to the node, the other terminal of the second fuse element F₂ is connected to the cathode of the second diode D₂ and the anode of the second diode D₂ is connected to a second voltage supply node (ground line). The second diode D₂ is, therefore, connected in reverse polarity between the ground line and the signal input terminal 10 via the second fuse element F₂.

Used as the input protection diode in the present invention is a planar type PN junction diode or the PN junction between the substrate and the drain region of a MOS transistor having the gate, source and substrate regions connected to each other.

In the LSI having the input protection device of the construction described above, the fuse elements F₁ and F₂ are in an uncut state before the LSI is actually mounted to an assembly circuit board. Therefore, the diodes D₁ and D₂ perform the ordinary input protection in the manufacturing process of the integrated circuit including the steps of sealing a silicon chip in a package, packing and transporting the packaged integrated circuit, and mounting the integrated circuit to an assembly circuit board.

To be more specific, the diodes D₁ and D₂ are biased in a reverse direction during the normal operation and, thus, the circuit operation is not affected. On the other hand, when a positive ESD is applied to the signal input terminal 10, the ESD is discharged to the V_{cc} voltage supply line as a forward current of the diode D₁ and is discharged to the ground line as a reverse current exceeding the breakdown voltage of the diode D₂, with the result that the ESD is prevented from reaching the internal element of the integrated circuit.

When a negative ESD is applied to the signal input terminal 10, the ESD is discharged to the ground line as a forward current of the diode D₂ and also discharged to the V_{cc} voltage supply line as a reverse current exceeding the breakdown voltage of the diode D₁, with the result that the ESD is prevented from reaching the internal element of the integrated circuit.

On the other hand, after the LSI is actually mounted to an assembly circuit board, the fuse elements F₁ and F₂ are cut off by the control from outside the LSI, making it possible to electrically isolate the diodes D₁ and D₂ for the input protection from the signal input terminal 10. As a result, after the mounting of the LSI to an assembly circuit board, it is possible to isolate the parasitic capacitance generated by the PN junctions of the diodes D₁ and D₂ from the input signal path. When it comes to an LSI operated under high frequencies in, for example, GHz range, the diodes D₁ and D₂ do not provide causes for inhibiting a high speed operation and permit improving the high frequency characteristics during the actual operation.

It should also be noted that, since the diodes D₁ and D₂ for the input protection are electrically isolated from the signal input terminal 10, it is possible to eliminate the possibility of occurrence of the latch-up phenomenon caused by the connection of the signal input terminal 10 of the LSI to the input protection diode. The particular effect can be produced by not only the LSI operated under high frequencies but also the general LSI.

What should also be noted is that any inconvenience is scarcely generated even if the diodes D₁ and D₂ for the input protection are electrically isolated from the signal input terminal 10 after the LSI is mounted to an assembly circuit board to make the input protection device unusable because the electrostatic capacitance of the entire assembly circuit board is large and the signal input terminal 10 of the LSI itself is less likely to be exposed to the outside so as to lower the necessity of the input protection.

The uncut/cut conditions of the fuse elements F₁ and F₂ will now be described.

The electrostatic discharge (ESD) that produces a problem in the handling of the LSI can be modeled like a capacitance discharge circuit shown in FIG. 3. In the drawing, V represents a DC voltage source, C represents a voltage source capacitance, R represents a voltage source resistance, and SW represents a switching element for switching the charging/discharging of the voltage source capacitance C.

Suppose the resistance R and the capacitance C of the equivalent circuit is 0Ω and 200 pF, respectively, in the case where the ESD is applied from various machines (machine model), and after the capacitor is charged, the charge is discharged to the signal input terminal of the LSI. Also suppose the resistance R and the capacitance C of the equivalent circuit is 1.5 kΩ and 50 pF, respectively, in the case where the ESD is applied from the human body (human body model), and after the capacitor is charged, the charge is discharged to the signal input terminal of the LSI.

If the LSI has an endurance of at least 500V in the case of the machine model and at least 2000V in the case of the human body model, the damage done by the ESD to the LSI is out of the question in the ordinary handling. In these cases, the energy of the ESD is consumed for generating heat in mainly the diode D₁ and D₂ for the input protection and the input wiring.

The electrostatic energy of the machine model under the DC power source voltage of 500V is 25 μJ, and the electrostatic energy of the human body model under the DC power source voltage of 2000V is 100 μJ. However, since the energy is consumed by the resistance R in the case of the human body model, all the energy is not applied to the LSI.

As apparent from the description given above, it suffices to assume that at most about 100 μJ of energy is consumed in the input protection device of the LSI. To be more specific, it is required for the fuse elements F₁ and F₂ not to be melted down and to maintain the conductance when an energy of 100 μJ is applied to the signal input terminal of the LSI and to be melted down when an energy larger than 100 μJ is applied to the signal input terminal. Incidentally, it is necessary for the current flowing into the diode D₁ for the input protection when the fuse F₁ is melted down to fall within an allowable range of the forward current. Likewise, it is necessary for the current flowing into the diode D₂ for the input protection when the fuse element F₂ is melted down to fall within an allowable range of the forward current.

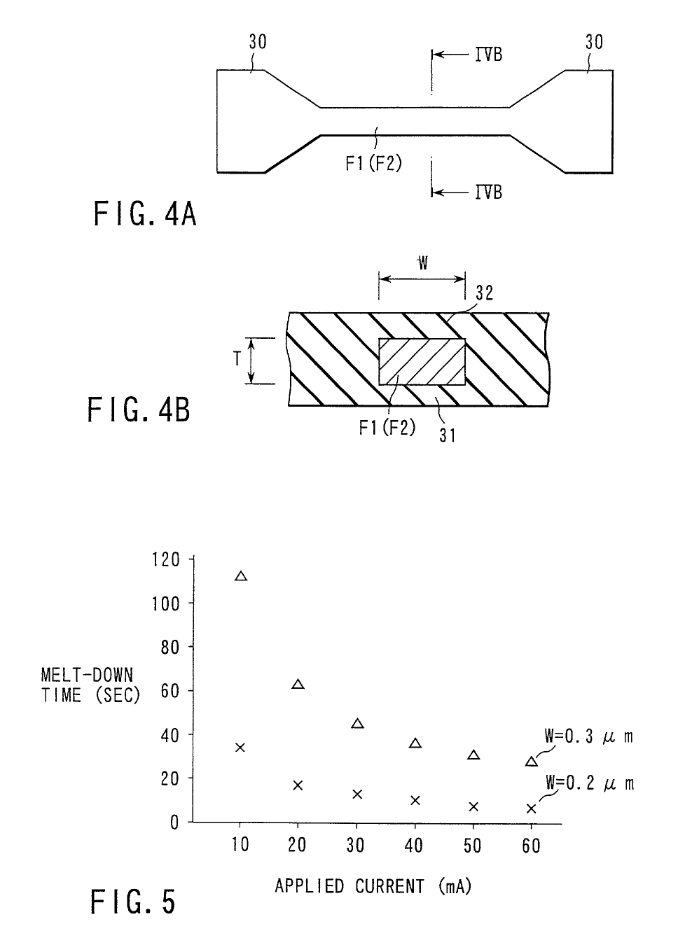

FIG. 4A is a plan view showing the construction of the fuse element F₁ or F₂ shown in FIG. 2, and FIG. 4B is a cross sectional view along the line IVB-IVB shown in FIG. 4A.

A metal wiring 30 is used in general for connection of the signal input terminal 10 of the LSI to the diodes D₁, D₂. The fuse elements F₁, F₂ can be formed by narrowing partly the metal wiring 30. In this case, each of the fuse elements F₁ and F₂ is surrounded by a lower insulating film 31 and an upper insulating film 32, as shown in FIG. 4B.

Where the metal wiring 30 is formed of, for example, an aluminum film, it is known to the art that heat is generated from the metal wiring 30 upon application of a DC current having a current density of a certain level. The particular current density, which differs depending on the heat conductance of the insulating films 31, 32 surrounding the metal wiring 30, is about 10⁷ A/cm².

FIG. 5 is a graph showing the experimental data in respect of the time required for the melting down of the aluminum wiring insulated with a silicon dioxide film. The experiment was applied to wiring films having a thickness T of 0.3 μm and width W of 0.3 μm and 0.2 μm. According to the experiment, no change was brought about in the characteristics of the fuse element upon application of 100 μJ of the ESD. Based on the experimental data, each of the fuse elements F₁, F₂ was formed of a wiring film having a thickness T of 0.3 μm and a width W of 0.2 μm.

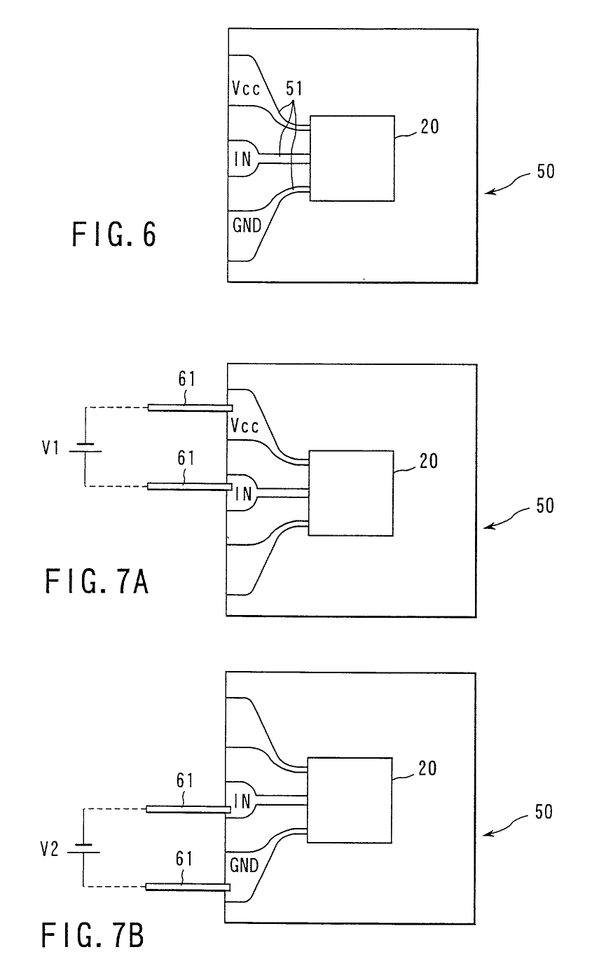

A second embodiment of the present invention will now be described with reference to FIG. 6. The second embodiment is directed to an LSI-mounted assembly circuit board having an LSI of the present invention mounted to the circuit board.

The LSI according to the first embodiment of the present invention is denoted by a reference numeral 20 in FIG. 6, with a reference numeral 50 denoting an assembly circuit board having the LSI 20 mounted thereon. In the assembly circuit board 50, a wring pattern 51 connected to a V_{cc} voltage supply line, a ground line, the signal input terminal 10, etc. of the LSI 20 is formed on an insulating circuit board. The end portion of the wiring pattern 51 is used as the terminals of the voltage supply wiring pattern V_{cc}, the ground wiring pattern GND, the signal input wiring pattern IN, etc. of the assembly circuit board 50.

Before the fuse elements F₁, F₂ of the mounted LSI 20 are cut away, the LSI-mounted assembly circuit board of the construction described above permits the diodes D₁ and D₂ to perform the ordinary input protecting function in the handling steps such as the packing and the transportation.

On the other hand, where the fuse elements F₁, F₂ are cut away by the control from outside the LSI so as to electrically isolate the diodes D₁ and D₂ for the input protection from the signal input terminal 10, it is possible to isolate the parasitic capacitance generated by the PN junction of the diodes D₁ and D₂ from the input signal path. It follows that, where the assembly circuit board is operated under high frequencies of, for example, GHz range, the diodes D₁ and D₂ for the input protection do not provide causes for inhibiting a high speed operation, making it possible to improve the high frequency characteristics during the actual operation.

It should also be noted that, since the diodes D₁ and D₂ for the input protection are electrically isolated from the signal input terminal 10, it is possible to eliminate the occurrence of the latch-up phenomenon caused by the connection of the input protection diode to the signal input terminal 10 of the LSI.

Incidentally, no substantial inconvenience is generated in the assembly circuit board even if the diodes D₁ and D₂ for the input protection are electrically isolated from the signal input terminal 10 so as to render the input protection device unusable because the electrostatic capacitance of the entire assembly circuit board is increased so as to lower the requirement of the input protection.

FIGS. 7A and 7B are directed to a third embodiment of the present invention. The third embodiment is directed to a method of removing the input protection function from an LSI under the state that the LSI according to the first embodiment is mounted like the LSI-mounted assembly circuit board according to the second embodiment, or the state that the LSI according to the present invention is incorporated in a product as a set and after the mounting in which the input protection device inside the LSI is electrically isolated from the signal input terminal by the control from outside the LSI.

Specifically, FIGS. 7A and 7B collectively show a method of removing the input protection function from an LSI-mounted assembly circuit board according to the third embodiment of the present invention.

In the first step, a prober 61 of a test apparatus is brought into contact with the signal input wiring pattern IN and the V_{cc} voltage supply wiring pattern of the assembly circuit board, as shown in FIG. 7A. Under this condition, a DC voltage V1 is applied between the signal input wiring pattern IN and the V_{cc} voltage supply pattern so as to permit a positive current of 30 mA to be applied to the signal input wiring pattern IN for at most 20 seconds, thereby cutting away the first fuse element F₁ shown in FIG. 2. In this case, the positive current applied to the signal input wiring pattern IN flows into the first diode D₁ shown in FIG. 2 as a forward current. However, since the current applied to the signal input wiring pattern IN falls within the allowable range of the forward current of the diode D₁, the diode D₁ itself is not damaged.

Then, the prober 61 of the test apparatus is brought into contact with the signal input wiring pattern IN and the ground wiring pattern GND of the assembly circuit board, as shown in FIG. 7B. Under this condition, a DC voltage V2 is applied between the signal input wiring pattern IN and the ground wiring pattern GND such that a negative current of 30 mA is applied to the signal input wiring pattern IN for at most 20 seconds, thereby cutting away the second fuse element F₂ shown in FIG. 2. In this case, the negative current applied to the signal input wiring pattern IN flows out as a forward current of the second diode D₂ shown in FIG. 2. However, since the negative current noted above falls within the allowable range of the forward current of the diode D₂, the diode D₂ itself is not damaged.

After the fuse elements F₁ and F₂ are cut away as described above, it is possible to confirm the predetermined operation of the LSI.

Incidentally, it is possible to allow the voltage applied to the signal input wiring pattern IN to have a lump wave form so as to gradually increase the applied current level until each of the fuse elements F₁ and F₂ is cut away.

Also, in order to remove as much as possible the influence of the parasitic capacitance of the wiring portion on the side of the diode of the wiring having the fuse elements F₁ and F₂ formed therein under the state that the fuse elements F₁ and F₂ are cut away, it is desirable to arrange the fuse elements F₁ and F₂ on those portions of the branched wirings, said branched wirings being branched from the main wiring extending between the input pad on the chip and the internal element of the integrated circuit and connected to the input protection diodes D₁ and D₂, which are positioned close to the branching point as much as possible.

It is possible to apply the technical idea of the present invention to the case where the first diode D₁ alone is arranged as an input protection device by attaching a much importance to the input protection relative to a positive ESD, and to the case where the second diode D₂ alone is arranged as an input protection device by attaching a much importance to the input protection relative to a negative ESD.

It should also be noted that the fuse elements F₁, F₂ are cut away by the current apply from outside the LSI, not by the laser beam irradiation. Therefore, in an LSI having a multi-layered wiring structure, it is possible to form the fuse element in an optional metal wiring layer included in the multi-layered wiring structure.

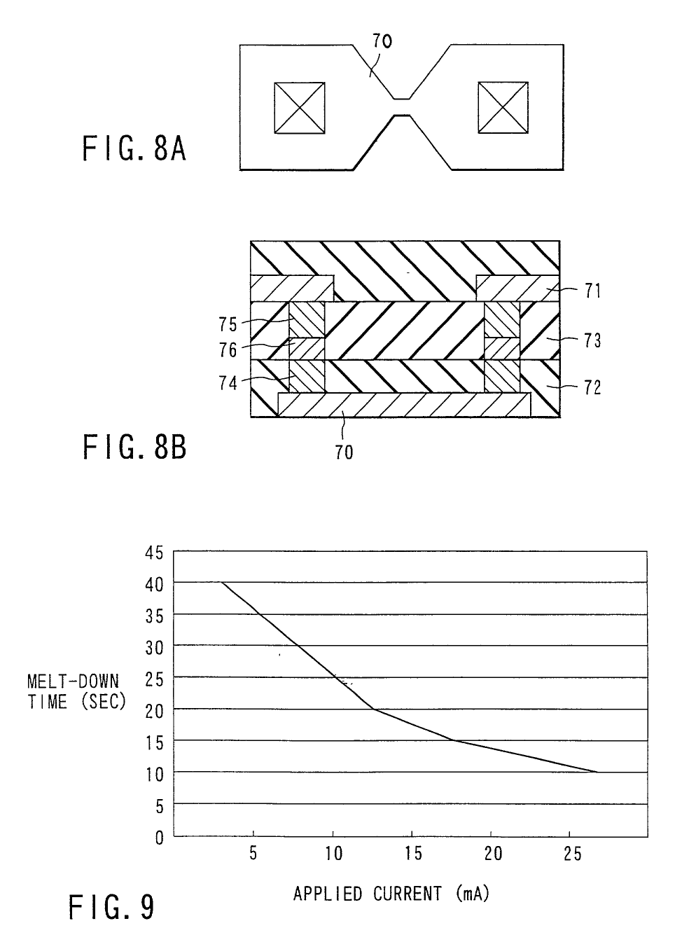

A fourth embodiment of the present invention will now be described with reference to FIGS. 8A and 8B.

The fuse element used in the present invention is not limited to the aluminum film used in the first embodiment of the present invention. It is possible to use another conductive film for forming the fuse element. Particularly, a polysilicon film widely used in an LSI exhibits excellent characteristics when used for forming a fuse element. A fuse element formed of polysilicon will now be described as the fourth embodiment of the present invention.

FIG. 8A is a plan view showing a fuse element connected to a protection diode within the input protection device of the LSI according to the fourth embodiment of the present invention, and FIG. 8B is a cross sectional view of a semiconductor substrate including the fuse element shown in FIG. 8A.

In this embodiment, the central portion of an oblong polysilicon film 70 formed in a lower portion of a multi-layered wiring structure on a semiconductor substrate is made narrower so as to utilize the central portion as a fuse element. The both end portions of the polysilicon film 70 are connected to a wiring 71 formed in an upper wiring layer through conductive plugs 74, 75 buried in interlayer insulating films 72, 73, respectively, and an interconnecting pattern 76 formed in an intermediate wiring layer.

The polysilicon film, which is generally used for forming a gate wiring layer of a MOSFET, is surrounded by a thick insulating film and, thus, exhibits a low thermal conductivity, compared with an aluminum film used as a metal wiring. Also, it is possible to apply a fine patterning to the polysilicon film, making it possible to achieve a fine patterning on the level of 0.1 μm by employing the fabrication technology in the same generation. It follows that, where the fuse element using a polysilicon film is processed to have a width of, for example, 0.1 μm, it is possible to obtain the merit that the melt-down of the fuse element can be achieved efficiently by the application of a DC current, compared with the fuse element formed of an aluminum wiring film.

FIG. 9 is a graph showing the relationship between the melt-down time and the applied DC current in respect of the fuse element formed of a polysilicon film as shown in FIGS. 8A and 8B.

As apparent from FIG. 9, the fuse element formed of a polysilicon film can be melted with a small DC current, compared with the fuse element formed of an aluminum film as shown in FIGS. 4A and 4B.

As described above, the present invention provides a semiconductor integrated circuit having an input protection device and an assembly circuit board of the semiconductor integrated circuit. According to the present invention, it is possible to prevent the device breakdown derived from an electrostatic discharge (ESD) during the handling steps such as the packaging of an integrated circuit chip, packing and transportation. It is also possible to electrically isolate the input protection diode from the signal input terminal during the ordinary use of the integrated circuit, making it possible to prevent the high speed operation of the integrated circuit from being inhibited by the presence of the input protection diode and to prevent the latch-up phenomenon. It follows that it is possible to achieve a circuit operation of a high performance.

The present invention also provides a method of removing the input protection function from the input protection device. According to the present invention, it is possible to make the input protection device dividable from the signal input terminal prior to the ordinary use of a semiconductor integrated circuit and an assembly circuit board of the semiconductor integrated circuit, thereby preventing the inhibition of a high speed operation and a latch-up phenomenon derived from the input protection diode.

According to the method of the present invention for removing the input protection function from the input protection device, it is possible to make the input protection diode dividable from the signal input terminal prior to the ordinary use of the semiconductor integrated circuit and the assembly circuit board of the semiconductor integrated circuit so as to prevent the high speed operation from being inhibited by the presence of the input protection diode and to prevent a latch-up phenomenon derived from the presence of the input protection diode.

According to the method of the present invention for removing the input protection function from the semiconductor integrated circuit and from the assembly circuit board of the semiconductor integrated circuit, the input protection diode can be divided from the signal input terminal prior to the ordinary use of the semiconductor integrated circuit and the assembly circuit board of the semiconductor integrated circuit before or after the semiconductor integrated circuit is mounted to the assembly circuit board.

In the embodiment of the present invention described above, the input protection diode is formed of a PN junction. However, the input protection diode is not limited to the PN junction. For example, in the case of using as the input protection device a Schottky type contact in which a metal film is formed in direct contact with a semiconductor substrate, the input protection device can be formed such that the metal film acts as an anode and the semiconductor substrate acts as a cathode. Further, the present invention can be modified in various fashions within the technical scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor integrated circuit having a gate input circuit and a protection device of said gate input circuit connected to a signal input terminal,
wherein said protection device comprises at least one protection diode;
a first terminal of said protection diode is connected to any of first and second voltage supply lines of the semiconductor integrated circuit;
a second terminal of the protection diode is connected to a node in an input signal path formed between said signal input terminal and said gate input circuit; and
said node and the second terminal of the protection diode are formed dividable by the control from the outside.

2. The semiconductor integrated circuit according to claim 1, wherein said gate input circuit comprises a MOS transistor including the gate for receiving the input signal supplied from said signal input terminal.

3. The semiconductor integrated circuit according to claim 1, wherein the first terminal of said protection diode is a cathode terminal of said protection diode, and any of the first and second voltage supply lines having said first terminal connected thereto is a voltage supply line on a high potential side of said semiconductor integrated circuit.

4. The semiconductor integrated circuit according to claim 1, wherein the first terminal of said protection diode is an anode terminal of said protection diode, and any of the first and second voltage supply lines having said first terminal connected thereto is a voltage supply line on a low potential side of said semiconductor integrated circuit.

5. The semiconductor integrated circuit according to claim 1, wherein said protection diode is formed of a PN junction, the first terminal of said protection diode is connected to an N-side of said PN junction, and any of said first and second voltage supply lines having said first terminal connected thereto is a voltage supply line on a high potential side of said semiconductor integrated circuit.

6. The semiconductor integrated circuit according to claim 1, wherein said protection diode is formed of a PN junction, the first terminal of said protection diode is connected to a P-side of said PN junction, and any of said first and second voltage supply lines having said first terminal connected thereto is a voltage supply line on a low potential side of said semiconductor integrated circuit.

7. The semiconductor integrated circuit according to claim 1, wherein a fuse element is formed dividable by the control from the outside between said node and the second terminal of said protection diode.

8. The semiconductor integrated circuit according to claim 7, wherein said fuse element is not cut away by the application of a pulse power of 100 μJ and is cut away by the application of a DC current of 30 mA for 20 seconds.

9. The semiconductor integrated circuit according to claim 7, wherein said fuse element is formed by partly narrowing an aluminum wiring and is insulated with a silicon dioxide film.

10. The semiconductor integrated circuit according to claim 7, wherein said fuse element is formed by partly narrowing a polysilicon film and is covered with an insulating film.

11. An assembly circuit board mounting a semiconductor integrated circuit on a circuit board, said semiconductor integrated circuit having a gate input circuit and a protection device of the gate input circuit connected to a signal input terminal,
wherein said protection device comprises at least one protection diode;
a first terminal of said protection diode is connected to any one of first and second voltage supply lines of the semiconductor integrated circuit;
a second terminal of the protection diode is connected to a node in the input signal path formed between said signal input terminal and said gate input circuit, a fuse element being formed between said node and the second terminal of said protection diode; and
said circuit board comprises a signal input wiring pattern connected to the signal input terminal and a voltage supply wiring pattern connected to any one of said first and second voltage supply lines.

12. The assembling circuit board mounting a semiconductor integrated circuit according to claim 11, wherein said gate input circuit comprises a MOS transistor including the gate for receiving the input signal supplied from said signal input terminal.

13. The assembling circuit board mounting a semiconductor integrated circuit according to claim 11, wherein the first terminal of said protection diode is a cathode terminal of said protection diode, and any of said first and second voltage supply lines having said first terminal connected thereto is a voltage supply line on a high potential side of said semiconductor integrated circuit.

14. The assembling circuit board mounting a semiconductor integrated circuit according to claim 11, wherein the first terminal of said protection diode is an anode terminal of said protection diode, and any of said first and second voltage supply lines having said first terminal connected thereto is a voltage supply line on a low potential side of said semiconductor integrated circuit.

15. The assembling circuit board mounting a semiconductor integrated circuit according to claim 11, wherein said protection diode is formed of a PN junction, the first terminal of said protection diode is connected to an N-side of said PN junction, and any of said first and second voltage supply lines having said first terminal connected thereto is a voltage supply line on a high potential side of said semiconductor integrated circuit.

16. The assembling circuit board mounting a semiconductor integrated circuit according to claim 11, wherein said protection diode is formed of a PN junction, the first terminal of said protection diode is connected to a P-side of said PN junction, and any of said first and second voltage supply lines having said first terminal connected thereto is a voltage supply line on a low potential side of said semiconductor integrated circuit.

17. The assembling circuit board mounting a semiconductor integrated circuit according to claim 11, wherein said fuse element is dividable by the application of a DC current from the outside.

18. A method of removing an input protection function from a semiconductor integrated circuit having a gate input circuit and a protection device of said gate input circuit connected to a signal input terminal, said protection device comprising at least one protection diode, a first terminal of said protection diode being connected to any one of first and second voltage supply lines of said semiconductor integrated circuit; a second terminal of said protection diode being connected to a node in an input signal path formed between said signal input terminal and said gate input circuit, a fuse element being formed between said node and the second terminal of said protection diode,
wherein said method comprises the step of cutting away said fuse element by applying a forward current flowing from an anode toward a cathode of said protection diode from said signal input terminal after manufacture of said semiconductor integrated circuit.

19. The method of removing an input protection function from a semiconductor integrated circuit according to claim 18,
wherein said semiconductor integrated circuit is mounted on a circuit board;
said circuit board comprises a signal input wiring pattern connected to the signal input terminal of said semiconductor integrated circuit and a voltage supply wiring pattern connected to any one of first and second voltage supply lines; and said method comprises the step of melting down said fuse element by applying the forward current flowing from the anode toward the cathode of said protection diode from said signal input wiring pattern formed in said circuit board to remove the input protection function from said semiconductor integrated circuit mounted on said circuit board.

20. The method of removing an input protection function from a semiconductor integrated circuit according to claim 19, wherein said gate input circuit comprises a MOS transistor including the gate for receiving the input signal supplied from said signal input terminal.
